(19) United States
(12) Patent Application Publication
(10) Pub. No.: US 2006/0019636 A1
(43) Pub. Date: Jan. 26, 2006

(54) Method and system for transmitting messages on telecommunications network and related sender terminal

(76) Inventors: Gianni Luca Guglielmi, Torino (IT); Gianluca Francini, Torino (IT); Claudio Lande, Torino (IT); Luca Bosonetto, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/524,941

(22) PCT Filed: Aug. 4, 2003
(86) PCT No.: PCT/EP03/08604

§ 371 Date: Feb. 8, 2005

(30) Foreign Application Priority Data
Aug. 14, 2002 (IT) TO2002 A 000724

(51) Int. Cl. H04L 12/58

(52) U.S. Cl. 455/412.1; 455/414.1

(57) ABSTRACT

The method comprises the steps of:- receiving (17) from a sender terminal (18) a text message, such as an SMS message,- integrating (16) said text message with a video content, to generate a multimedia message, and- transmitting (10) to at least a recipient terminal (12, 13, 14) said multimedia message in the form of an MMS message. The possible coexistence and interoperability of traditional mobile terminals (e.g. GSM) with new generation mobile terminals (e.g. UMTS) is thereby assured.

### TECHNICAL FIELD

The present invention relates to the transmission of messages on telecommunication networks.

### BACKGROUND ART

The introduction of new generation mobile terminals, for instance according to the UMTS standard (Universal Mobile Telecommunications System) or the GSM/GPRS standard (acronyms for Global System for Mobile communications and General Packet Radio Service) has enabled the transmission and presentation on terminal of messages with multimedia content comprising different elements, such as text, sounds and images, also in motion. Said messages are currently indicated as MMS, acronym for Multimedia Messaging System.

The capability of transmitting said messages gives rise to different kinds of problems.

In the first place, it is necessary to ensure that said messages can be constructed with relative ease by using an apparatus, like a mobile telephone, which, due to the reduced size and processing capacity, is not ideally suited for generating messages with complex content.

In the second place, it is desirable for terminals with the ability to transmit and receive MMS messages to be able to coexist and interact with old generation terminals such as mobile terminals operating according to the GSM standard, able to generate only text messages of the type currently called SMS, acronym for Short Message Service. It is reasonable to think that the two technologies are destined to coexist for a fairly long time before all currently circulating terminals are replaced.

### DISCLOSURE OF THE INVENTION

The aim of the present invention is to favour the coexistence and the interaction between terminals with the ability of transmitting text messages like SMS message and terminals able to receive MMS messages.

According to the present invention, said aim is achieved thanks to a method with the characteristics specifically set out in the claims that follow. The invention also includes the related system as well as the corresponding sender terminal.

In essence, the solution according to the invention allows old generation terminals—able to send SMS text messages—to induce the generation of messages with multimedia content, destined to MMS terminals.

In the currently preferred embodiment, the solution according to the invention allows to provide a service that automatically transforms a pure text message into a multimedia message, hence into a “richer” message than the starting message, constituted by the pure text.

In the currently preferred embodiment, the solution according to the invention provides for using the system for the automatic automation of three-dimensional characters based on text or natural audio produced by the same Applicant and identified by the registered trademark JoeXpress®.

In this regard it is useful to consult the documents EP-A-0 991 023, EP-A-0 993 197 and WO-A-01/75805. The system in question is able to transform a text or a recorded voice into the movements of a character who enunciates the processed sentences. Said movements also include movements that are not linked with the spoken word, with facial expressions and body motions. The system is also able to handle other elements such as the personalisation of the character's appearance (for example, the colour of the hair, of the eyes, the way it is dressed, etc.), the place where the character is positioned, the movement of the viewing point, the background music. All concurs in the construction of a video clip from a restricted number of input parameters provided.

In this way, the solution according to the invention allows, for instance, to generate animations destined to MMS terminals on the basis of the text contained in a starting SMS message. In this case, the result is an MMS message comprising different parts, such as the scene description part (in “Synchronised Multimedia Integration Language” or SMIL) and the parts containing the multimedia objects to be inserted in the message, among which are automatically generated animations.

The first generation of MMS terminals is subject to fairly stringent constraints on message content: in particular, video is not supported and the maximum size of the messages is 30 kBytes. A preferred embodiment of the solution according to the invention therefore allows to incorporate in the generated MMS message an animation with small size. In particular, the video is transformed into an image according to the GIF standard (acronym for Graphics Interchange Format) subjected to animation using a rather low animation sampling rate, i.e. around one Hz.

Moreover, the original text is subdivided among the various frames of the sequence. By doing so, with animations having, for example, sizes in the order of 100×80 pixels (the dimensions of the display units of currently marketed MMS terminals) one can generate messages containing animations lasting about 15 second, with complex models and scenarios, or longer in the case of simpler models, which allow a higher compression ratio within the animated GIF image.

If the total size of the message is limited (for instance, to 30 kBytes) making it problematic to transmit both video and audio, it is possible to cause the terminal, during the viewing of the animated GIF image, to reproduce, instead of a voice message, a melody inserted in the message: this type of sound (“ringer”) is able to be contained in a very small number of bytes.

In the presence of less strict constraints on the size of the message, the solution according to the invention allows to transmit, instead of text inside the frames or even in parallel therewith, the audio associated with the animation, generated for instance by a voice synthesiser. In this scenario, it is possible automatically to generate an MMS message even from natural audio, in which case the animation is guided by the result of the process carried out by a phonetic recogniser. Voice synthesisers and phonetic recognisers able to carry out the functions described above are currently available in the art.

In addition to animation, the MMS message can advantageously contemplate a part destined to contain more text, melodies and images, useful for inserting, for instance, so-called “logos” and/or advertising slogans.

### BRIEF DESCRIPTION OF DRAWINGS

The invention shall now be described purely by way of non limiting example with reference to the accompanying drawings, in which:

FIG. 1 shows, at functional architecture levels, the structure of a system able to operate according to the invention,

FIG. 2 is a flow chart illustrating the steps for transmitting a message according to the invention, and

FIG. 3, comprising two parts indicated respectively as 3A and 3B, reproduces two contiguous parts of a functional block diagram illustrating a possible form of arrangement of the system according to the invention.

### BEST MODE FOR CARRYING OUT THE INVENTION

The description provided herein refers to the application scenario which, at least at present is the most attractive one for the possible use of the invention, i.e. the conversion of text messages generated as SMS messages in a GSM mobile terminal into MMS messages destined to be transmitted on a network operating according to the UMTS standard.

In any case, the solution according to the invention is also applicable to text messages generated differently, for instance in the form of email messages, and it can be used to transmit MMS messages on any type of network such as to support such a transmission, hence without limitation to UMTS networks.

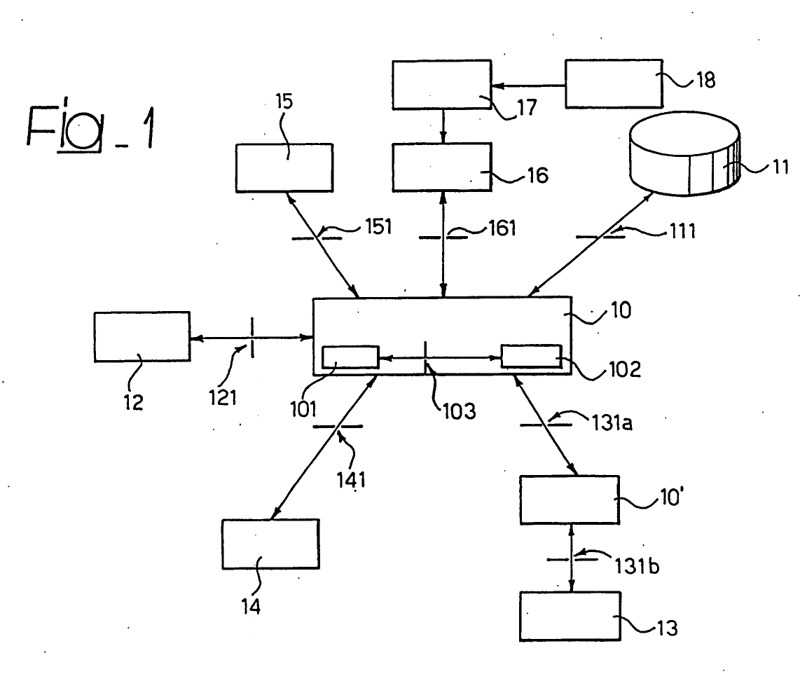

In the diagram of FIG. 1, the numeric reference 10 globally indicates a module having the function of MMS relay/server and comprising for this purpose a sub-module with relay function, indicated as 101, and a sub-module with server function, indicated as 102, mutually connected through an interface indicated as 103. Naturally, the sub-modules 102 and 103 can also be mutually integrated.

The numeric reference 11 instead indicates a database of the users of an MMS service. This is substantially a database where, for each user to whom the MMS service is made available, the telephone number (or an equivalent indication) and the information about the terminal type employed by the user in question are recorded.

The database 11 is connected to the module 10 through an interface 111.

The numeric references 12 and 13 indicate two users connected in a network to the module 10 (this can typically take place through an UMTS network) so as to be able to receive MMS messages.

The user indicated as 12 is a user directly included in the network whereto the module 10 is attached. The related connection therefore is of the direct type, through an interface indicated as 121.

The user indicated as 13, instead, is a user nominally attached to another mobile network.

In this case, the connection to the module 10 is not direct but is achieved through an additional module 10′ substantially similar to the module 10, by means of corresponding interfaces indicated as 131a and 131b.

The distinct representation of the user 12 and of the user 13 is destined to highlight the possibility of applying the solution according to the invention also in a context in which multiple telecommunication networks mutually co-operate in a general internetworking or roaming scenario.

The reference 14 indicates a server, such as an electronic mail server, connected to the module 10 through a respective interface 141 in order to be able to operate as a recipient of MMS messages.

Lastly, the reference 15 indicates the system for billing the rendering of the MMS message services, connected to the module 10 through a respective interface 151.

The system architecture and the various constitutive elements described heretofore correspond to solutions to be considered wholly known in the art. These solutions are already able to be used for sending MMS messages within telecommunications networks (such new generation mobile networks operating according to the UMTS standard). This fact makes it superfluous to provide herein a more detailed description of the architecture and of the elements in question.

An important characteristic of the solution according to the invention is given by the fact that to the module 10 it is associated, preferably through a respective interface 161, a module or sub-system 16 able to convert text-only messages, such as SMS messages coming from an SMS message management centre 17 (usually called with the acronym SMSC) into messages with multimedia content. After possible further processing in module 10, said messages can be broadcast by the module 10 in the form of MMS messages destined to users such as the users 12, 13 and 14 indicated in FIG. 1.

In particular, the module 10 can be configured in such a way as to allow the transmission of a determined message MMS to multiple recipients or to a list of recipients. Consequently, though hereinafter reference shall be made nearly exclusively to the generation, from an SMS message, of an MMS message sent to a single recipient, the solution according to the invention is easily suited to allow the MMS message in question to be broadcast to a list of recipients defined for instance by means of an http request or by means of an ftp request sent to the module 10.

As stated previously, the core of the module 16 is constituted by the system for the creation of multimedia content represented by virtual characters animated by text or natural voice. An example of such a system is the JoeXpress® system, mentioned above.

Such a system enables a user to select a virtual character, its background, any personalisations, the format in which the content is to be produced. The selected parameters are used to produce animations with the desired context and format.

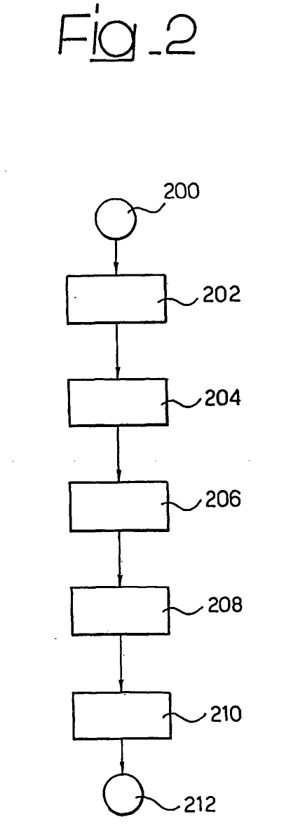

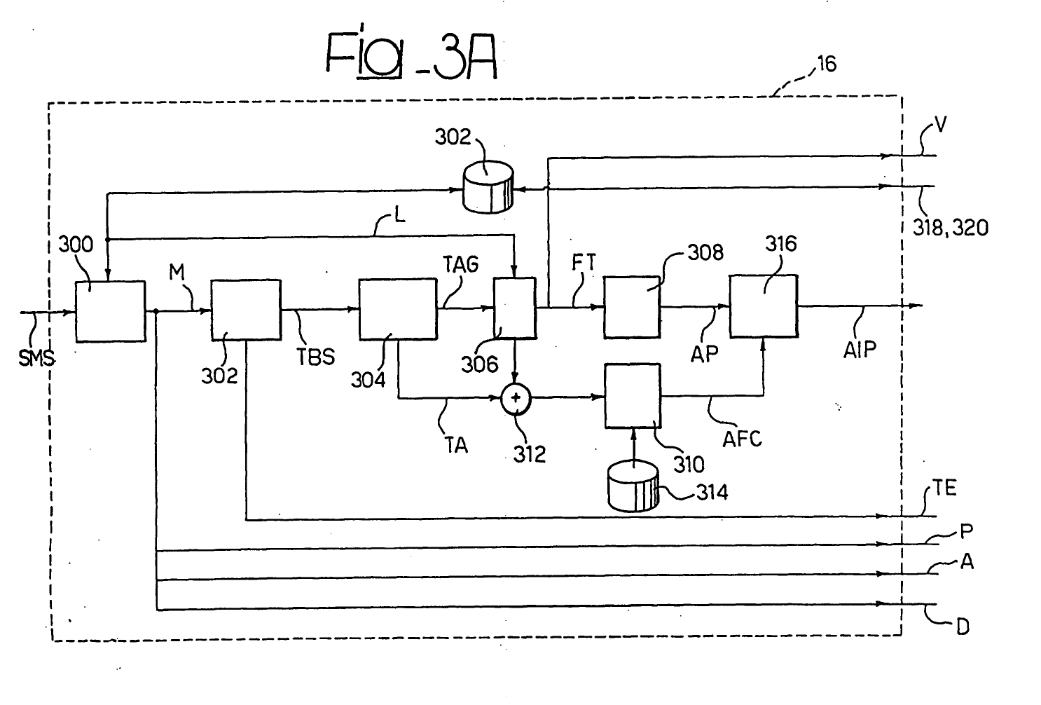

The flowchart of FIG. 2 shows the steps of the process whereby a system according to the invention is accessed by a user, indicated as 18 in FIG. 1, who acts as a “sender”. The user 18 has a terminal able to send SMS messages to a corresponding centre able to handle this type of messages, such as the centre indicated as 17 in FIG. 1.

Starting from an initial step, indicated as 200, the reference 202 indicates the step in which the user 18 composes on his/her terminal an SMS message (with the characteristics better illustrated hereafter) sending it to a telephone number associated with the service which forwards said SMS message after providing it with MMS characteristics.

The service in question is implemented mainly by the module indicated as 16, but some functionalities can be performed by the module 10 and, possibly, by the module 17.

In the step indicated as 204 in FIG. 2, the service management function—hence essentially the module 16—generates the request for the emission of an MMS message corresponding to the received SMS message. As will be explained better hereafter, such a request contains, in addition to the message itself, also the user's identifier and (possibly) information pertaining to the type of recipient terminal.

In the step indicated as 206, the module 16 processes the request received, generating an MMS message adapted to the graphic and processing capacity characteristics of the recipient terminal. In the step indicated as 208, said MMS message is sent to a corresponding MMS centre (such as the module 10) which, in a subsequent step 208, forwards the message to the recipient terminal, such as the terminal 12, 13 or 14.

The step 210 indicates the step in which said message is presented to the recipient terminal according to the typical modes of presentation of an MMS. Once the transmission is completed with the reading of the MMS message, the system moves to a conclusive step, indicated as 212.

The telephone number associated with the service, destined to be dialled by the user 18 in the step 202 is preferably a dedicated telephone number of the kind usually called “large account”.

The sequence of characters sent by the user contains, in addition to the text of the message, also some information in the header such as the telephone number of the recipient of the MMS message (users 12, 13, 14 of the diagram of FIG. 1), the virtual character that will reproduce the message and the background into which it will be inserted.

The last two information items are optional and can therefore be omitted. In case of omission, corresponding information are selected automatically by the module 16, for instance as a random choice or as a predefined choice (default). Naturally, this can be applied even for only part of said information: for instance, if only the character is specified, the module 16 automatically selects the background.

The sequence of characters sent to the service therefore usually has the following form:
<recipient telephone number>[<virtual character[<background>]]<text message>

In the step 202 the header of the message can be composed either manually or by means of a script residing on the terminal 18 which allows to select the virtual character and the background by means of a menu and the recipient from the address book.

If the message is dialled manually, the sequence of characters can contain errors. For example, the user could specify the name of a non-existing virtual character or background. In this case, the service replaces the faulty information by automatically selecting correct options.

It will be appreciated that said script functions correspond essentially to functions provided in some mobile telephony terminals for sending SMS messages, with the possibility to load the related software remotely in the individual terminal 18 (in particular in the Subscriber Identity Module or SIM of the terminal) by the same service management system.

The module for transforming the SMS text format into MMS multimedia format, preferably based on the JoeXpress® systems already mentioned several times above, is preferably used in the mode called “text animation”.

In this case, the text of the SMS message is processed by a voice synthesiser which transforms the text into voice and provides the timed phonetic sequence, which is then used for the automatic generation of the speech movements of the selected virtual character. The text provided as an input to the SMS/MMS conversion module may contain meta-information that have an influence over the resulting animation, adding expressions and gestures to the virtual characters and altering the synthetic voice.

Said meta-information are inserted in the text as sequences of characters that can have, for instance, the following form:
<tag><action_type>[<par1>][<par2] . . . [<parn>]
where:
<tag> is necessary to distinguish the meta-information from the text to be synthesised
<action_type> specifies which action is to be executed. Examples of actions are: change in voice timbre, reproduction of a facial expression or of a body movement, change in viewpoint, etc.
<par1-n> is the parameter that modifies the action, for instance the alteration of the duration of a facial expression.

An alternative representation at higher level is constituted by the so-called “emoticons”, i.e. by sequences of characters commonly used in Internet in text communications, which represent emotional states. Examples of emoticons are: “;-)”, “:-)”, “:-O”, etc.

Emoticons are transformed by the system into a semantically equivalent form using the representation described above. Support to the emoticons is motivated by the fact that they are familiar to users and simple to insert in the text, while having the same flexibility as low level representation.

A system like the JoeXpress® system produces animations of three-dimensional models that can be translated by the system into different formats, classifiable in two categories depending on whether the three-dimensional information is retained or not.

To the first category belong, for instance, the sequences of MPEG-4 Face and Body Animation parameters, VRML animations (acronym for Virtual Reality Modelling Language), 3D Studio Max animations etc.

To the second category belong the video coding formats like MPEG-1, MPEG-2, MPEG-4 video, animated GIF (while it is not a video coding format in the strict sense of the term, the GIF-89a format does allow to create image sequences).

The audio of the animation can be encoded together with the video or separately as in the case of VRML or animated GIF.

Due to the limits in the terminals of the transmission network, multimedia contents are subject to constraints such as the maximum size of the message, spatial resolution, time resolution, and the type of coding of the animation.

For this reason, in addition to the text of the message and to the identifier of the sender, it is necessary to take into account the type of terminal whereto the multimedia message is to be transferred.

The terminal type essentially identifies the class of the terminal (in essence, characteristics such as storage capacity, display size, etc.) and any other constraints due to the transmission network.

The MMS message destined to be produced in a system according to the invention is therefore conditioned to exploit the available resources most efficiently, within the imposed constraints.

This requirement can be met in at least two different ways.

A first way provides for the request to create the MMS message, generated at step 204, to contain, in addition to the text of the message and the sender's identifier, also information indicating the class whereto the message to be generated must belong, i.e. the type of terminal whereto the MMS message is destined and hence its performance characteristics. The video content destined to integrate the SMS textual message is then generated according to the recipient terminal type, i.e. in such a way as to cause the MMS message (derived from the multimedia message obtained by integrating said video content and the SMS message) to be directly compatible with the characteristics of the MMS terminal destined to receive the multimedia message.

When this solution is adopted, the module 16 is able to search, based on the recipient's identifier, the terminal type information stored in the database 11. The connection between the module 16 and the database 11 can be either of the direct or of the indirect type, through the module 10, according to the criteria whereto FIG. 1 refers.

A second way to obtain the same result provides for the multimedia video content (destined to be added to the SMS message) to be generated by the module 16 on the basis of criteria that are standard, hence independent from the type of terminal whereto the message is destined to be transmitted.

The multimedia message deriving from the integration between the SMS textual message and said standard multimedia video content is forwarded by the module 16 to the module 10 which, reading the information about the recipient terminal from the database 11, “specialises” the MMS message derived from the multimedia message, adapting it to the characteristics of the recipient terminal.

The choice to adopt one or the other solution is primarily dictated by application considerations.

The first solution has, at least in principle, the advantage of not entailing the generation of information destined to be discarded when the message is adapted to the requirements of the recipient terminal. However, this advantage is offset by the need to ensure that the module 16 is able to receive the information about the type of terminal, residing in the database 11.

The second solution has the advantage that it exploits the availability of the information of the database 11 at the level of the module 10, already normally provided for current MMS applications. In current MMS applications, the module 10 is already capable of achieving a specialisation of the forwarded MMS messages according to the characteristics of the recipient terminal. The advantages indicated above, however, are at least marginally tempered by the fact that this solution entails the generation, by the module 16, of information destined to be discarded.

Whichever solution is adopted, it is possible to benefit from the fact that the same animation can be represented in an MMS message in substantially different manners.

For instance, one can make use, as stated previously, of an animated GIF image with a low number of frames per second, in which case each frame shows the text of the message pronounced at that instant by the character. This particularly compact representation is well suited for situations in which the message size constraints are particularly stringent, or when the recipient terminal is not able to show a video.

Alternatively, one can employ an animated GIF image, with compressed audio. In this case, the synthesised voice, possibly complete with scene audio, is also included in the message. This is a useful representation for terminals that do not support video but are able to handle audio, when the size of the message is sufficiently large to contain both the moving image and the audio track.

An additional alternative is represented by a video clip complete with audio. In this case, an animation is obtained that can be more fluid in its motions thanks to the higher compression ratio offered by a video coding with respect to an animated GIF image and to the higher number of frames consequently used in the animation. This solution can be adopted with terminals that are able to support video coding.

It should be stressed that the ways to package the message recalled above are mere examples, and they are far from being exhaustive of the possibilities offered by the solution according to the invention.

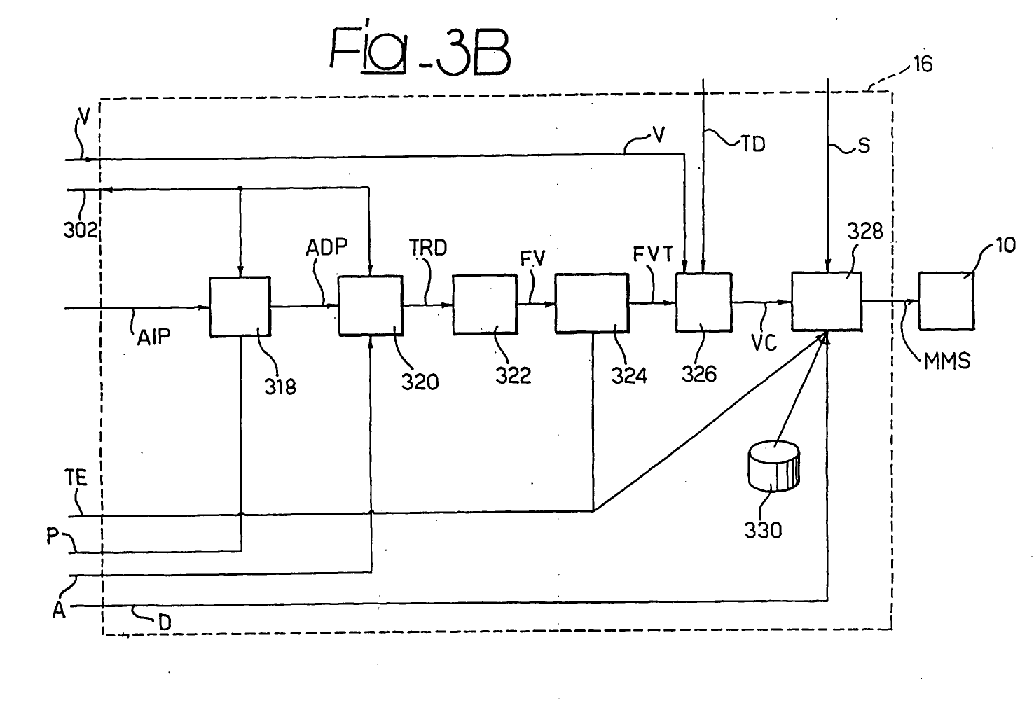

The description will now be provided, with reference to FIGS. 3A and 3B, of a possible architectural arrangement of the module indicated as 16 in FIG. 1.

The block or module 300 is destined to receive as its input the SMS message substantially as transmitted by the terminal 18 and to perform thereon the operation of extracting the information from the header.

As previously seen, the first part of the text is represented by a header containing the number of the recipient terminal (for instance, with reference to the diagram of FIG. 1, the terminal 12, the terminal 13 or the terminal 14) and, optionally, the indication of the character and of the background which the sender user wants to use to generate the video content. These data are divided from the actual message by a separator character. The message can contain low or high-level meta-information (for instance the so-called emoticons) which influence the resulting animation.

As an example of such text, one can consider the string:
“3356121180 Morpheus Country@Hi! I'm at the beach: -) but I'm getting bored without you. \kyawn,150”.

In the example, the separator used is the character @.

Associated to the message in question are the identifier of the sender as well as, possibly, the string indicating the recipient's terminal model.

The reference 302 indicates the database of the module 16 which, in the preferred implementation based on the JoeXpress® system, contains information such as the list of characters usable for generating the video content, the languages associated to them, the available scenarios, etc. The database 302 also contains the three-dimensional models of the characters and of the backgrounds.

Co-operating with the data base 302, the block 300 extracts from the message header information such as the recipient's identifier, as well as the character and the background to be used to create the video content.

The block 300 then communicates with the database 302 that contains the character list, voices, available backgrounds and, if these information are omitted or erroneous in the header of the received SMS message, the block 300 automatically selects correct options.

The block 300 generates at its outputs the following data/information:
the text of the message without the header (“HI! I'm at the beach :-) but I'm getting bored without you. \kyawn,150”) destined to be sent to an additional block 302 whose function shall become more readily apparent hereafter;
the name of the character P, protagonist of the animation (in the example illustrated herein, said name is “Morpheus”),
the language L associated with the character (for instance, English),
the background A corresponding to the scenario in which the virtual character P is to be placed (in the example considered herein, the background is a “country” background), and
the identifier of the recipient D (constituted, in the illustrated example, by the number 3356121180).

Starting from the text of the message M received from the block 300, the block 302 transforms the emoticons into meta-information capable of being used by the information system that simultaneously determines what text will be inserted in the frames constituting the animation of the MMS message constituting the output of the module 16.

Therefore, the output of the block 302 is constituted both by a text TBS with low-level information, i.e. a text in which emoticons are replaced with low-level meta-information (““Hi! I'm at the beach \ksmile but I'm getting bored without you. \kyawn,150”), and a text TE in which all low-level information has been eliminated, retaining only what will be said by the character plus the emoticons (“Hi! I'm at the beach :-) but I'm getting bored without you.”).

The text TBS generated by the block 302 is sent to a block 304 destined to extract the list of actions contained in the text and to prepare the text in the form used by a voice synthesiser 306 in such a way as to obtain also the timing to be associated to the aforesaid actions.

The block 304 transmits to the synthesiser 306 a text TAG in which the low-level meta-information are replaced with “tags” of the voice synthesiser (text-to-speech). Said tags are sequences of characters identified by the synthesiser as special information and used either to alter the synthesised voice or to obtain from the synthesiser 306 the time instants associated to the tags in the synthesised sentence. Said time instants are used to determine the timing of the actions.

The block 304 also generates as an additional output a signal TA substantially corresponding to a list of the actions contained in the text, complete with any parameters.

Referring to the SMS message mentioned several times above, there are essentially two actions contained, i.e.:
smile, and
yawn, 150.

The parameter 150 modifies the duration of the “yawn” action with respect to a standard duration.

The voice synthesiser 306 transforms into a voice signal the text TAG received from the block 304 using the selected language identified by the signal L generated by the block 300.

In addition to the voice signal, the block 306 also produces the timed phonetic sequence FT, used as the basis of the construction of the movement of the spoken word. It should be recalled that the timed phonetic sequence is the sequence of phonemes constituting the spoken sentence, integrated with the time instances whereat the phonemes are spoken.

The signal indicated as V is, instead, the actual synthesised voice signal.

The blocks indicated with the references 308 and 310 are engines that supervise the animation of the spoken word and the corresponding facial and body animation of the character used for the video content.

The block 308 receives as an input the phonetic sequence FT transforming it into a “visemic” sequence, i.e. into the movement produced by the face as it speaks. To obtain a realistic movement, the animation engine considers the mutual influence effect of adjacent phonemes, said co-articulation phenomenon. The movement produced is three-dimensional and the related output signal AP is constituted by animation parameters that describe the movement of the spoken word in three-dimensional fashion and independently from the character. This means that such parameters are successively applicable to characters with any shape and complexity, human and otherwise.

The block 310, serving as facial and body animation engine operates on the basis of the list of actions corresponding to the signal TA generated by the block 304 integrated in a virtual summation node 312 with the information on the timing of the actions, generated by the synthesiser 306.

The block 310 operates in co-ordinated fashion with an additional database 314 which contains sequences of facial and body movements in the form of animation parameters independent from the character, thus similar in this regard to the parameters output by the block 308. In the example, the sequences “smile” and “yawn” are two movements drawn from the database 314.

The facial and body 310 animation block unites the individual actions corresponding to the various movements that the character will have to perform, creating a single sequence of animation parameters. The individual movements are altered based on any parameters associated therewith. The movements also undergo automatic variations in intensity, duration, specular characteristics, etc. to enhance variety. Lastly, some movements executed by the characters but not explicitly indicated, such as blinking eyelids, are also added.

The output of the block 310 is constituted by a signal AFC representative of animation parameters that describe the movement of the spoken word in three-dimensional fashion, independently from the character. Said parameters are, therefore, successively applicable to characters with any shape and complexity, human and otherwise, such as animals.

A successive block indicated as 316 has the task of mixing the movements of the spoken word (signal AP) with the other movements (signal AFC) to obtain a realistic result. The operation of the block 316 is based on a logic that takes into account the priorities of movements that may be contrasting, such as speaking a plosive phoneme (such as the letter “p”) and yawning. The resulting movement is three-dimensional.

The output signal of the block 316 is constituted by a signal AIP representative of an animation independent from the character.

The signal AIP is fed to a block 318 that transforms the independent animation (signal AIP) into the movement of the character selected on the basis of the signal P extracted from the block 300. The resulting movement is dependent on the topology of the model. The model associated with the character is, as seen previously, contained in the database 302.

The output signal of the block 318 is constituted by a signal ADP identifying the sequence of movements of the selected character.

The signal ADP in question is fed to a block 320 that merges the signal ADP with the background information A that comes from the block 300 with additional information on the characters and on the backgrounds drawn directly from the database 302.

All this in order to add to the animation of the character also the remaining animations which may be present in the scene (signal A) and can be driven by means of the meta-information in the text, as movement of objects or change of the viewpoint of the shot.

The output signal of the block 320 is constituted by a final three-dimensional animation signal TRD destined to be sent to a block 322 tasked with the rendering operation, i.e. with the operation of representing on a screen, as a pixel matrix, the three-dimensional scene constituted by the character and by the background. The sequence of said pixel matrix, obtained at regular time intervals, constitutes the output of said block. The output of the rendering block 322 is constituted by a sequence of video frames of the animation indicated as FV. The sampling rate of the video frames is a parameter that is typically set in preferred fashion to 25 Hz.

The signal FV is fed as an input to an additional block 324 destined to receive also the text with emoticons TE generated by the block 302.

The block 324 distributes the text among the various frames constituting the video animation produced. Said operation is optional and is performed when an MMS message without audio is to be generated, i.e. an MMS message in which the SMS message is shown in the form of text and animation.

The output of the block 324 is constituted by the set of all movements of the character and of the scene. Said signal FVT, corresponding in practice to the sequence of the video frames with the text, is fed to a video coding block 326 destined to receive as its input, in addition to the signal FVT, also the signal V pertaining to the synthesised voice as well as the information TV pertaining to the type of terminal of the recipient.

The embodiment shown in FIGS. 3A and 3B refers to a solution in which said information is made available at the level of the module 16. Said information generally indicates brand and model name of the recipient terminal (for example, Sony Ericsson T68i, Nokia 7650, etc.).

The block 326 proceeds in this case by creating the video clip directly in a format suitable to be viewed from the recipient terminal in question. The adaptation of the video clip to a determined type of terminal can influence, for example, on the spatial and time resolution of the frames, on whether the audio channel is inserted or not, etc.

The solution whereto reference is made herein therefore provides for integrating the SMS message with a video content generated in this way so that the resulting multimedia message, generated by the module 16, is in a format suitable for being viewed from said terminal.

As stated previously, the solution according to the invention can, however, also be implemented in conditions in which the module 16 (and, therefore, the block 326, in the embodiment illustrated herein) does not carry out any “specialisation” action of this kind.

In this case, the video clip, or in general the video content destined to complement the incoming SMS text message, is generated in a standard format, i.e. without taking into account the characteristics of the recipient terminal.

The related format conversion, destined to make the final MMS message actually viewable by the recipient terminal, is then left to the module 10 (FIG. 1) with MMS relay/server functions.

In the embodiment example illustrated herein (which is in fact an example) the output signal from the block 326 is then constituted by a signal VC essentially similar to a video clip in compressed format.

Said signal is transmitted to a block 328 destined to construct, starting from the multimedia message carried at its input, a message corresponding to the MMS standard.

To proceed in this way, the block 328 receives at its input, in addition to the signal VC output by the block 326, also the signal TE corresponding to the text with emoticon generated by the block 302, the signal pertaining to the recipient D coming from the block 300, as well as the information about the sender S: the latter information is derived from the centre 17 of FIG. 1 according to known criteria, requiring no detailed description herein.

To generate the MMS message, destined to be sent to the module 10, the block 328 inserts the video animation previously computed in an MMS message. This preferably takes place using the SMIL language of description of the scene and joining various multimedia objects in a single form comprising multiple parts.

The block 328 also inserts in the message header the information about the sender, recipient and subject. The subject is constructed automatically using the first characters constituting the text with emoticons.

Preferably, the block 328 is also destined to co-operate with an additional database 330 constituted by a collection of images to be inserted in the MMS message as “logos” or advertising, or as sounds able to be used as background music for the scene or as advertising jingles.

Naturally, without changing the principle of the invention, the details of its implementation and the embodiments may be amply varied with respect to what is described and illustrated herein purely by way of example, without thereby departing from the scope of the present invention. This holds true in particular, but not exclusively, for the possibility of applying the invention to convert into MMS messages text messages generated other than by an SMS, for instance in the form of e-mail messages, and to the possibility of applying the invention to the transmission of MMS messages on other than UMTS networks.

1. Method for transmitting messages on a telecommunications network, characterised in that it comprises the steps of:
receiving (17) from a sender terminal (18) a text message,
integrating (16) said text message with a video content, to generate a multimedia message, and
transmitting (10) to at least a recipient terminal (12, 13, 14) said multimedia message in the form of an MMS message.

2. Method as claimed in claim 1, characterised in that it comprises the step of receiving (17) said text message in the form of an SMS message.

3. Method as claimed in claim 1 o claim 2, characterised in that it comprises the steps of:
identifying the type of recipient terminal (12, 13, 14) able to receive said multimedia message by identifying the characteristics of said recipient terminal, and
adapting (16,326;10) said MMS message to the characteristics of said recipient terminal (12, 13, 14).

4. Method as claimed in claim 3, characterised in that it comprises the step of integrating said text message with a generated video content (326) in such a way that said multimedia message is suited to the characteristics of said recipient terminal (12, 13, 14).

5. Method as claimed in claim 3, characterised in that it comprises the steps of:
complementing said text message with a video content determined independently from the characteristics of the recipient terminal (12, 13, 14) and
adapting (10) the multimedia message thereby obtained to the characteristics of said recipient terminal (12, 13, 14).

6. Method as claimed in any of the previous claims, characterised in that it comprises the step of selecting said video content within the group constituted by:
an animated image,
a background image, and
an image with variable viewpoint.

7. Method as claimed in any of the previous claims, characterised in that it comprises the step of synthesising from said text message a voice signal (V) able to be associated to said video content within said multimedia message.

8. Method as claimed in claim 7, characterised in that it comprises the step of generating said animated image (308, 310) as an image of a character who speaks the synthesised voice signal corresponding to said text message.

9. Method as claimed in claim 8, characterised in that it comprises the step of generating the image of said character by means of a text animation system (308, 310).

10. Method as claimed in any of the previous claims, characterised in that it comprises the step of integrating (328) said MMS message with background music (330).

11. Method as claimed in any of the previous claims, characterised in that it comprises the step of including in said video content an animated GIF image.

12. Method as claimed in any of the previous claims 6, 8, 9 or 11, characterised in that said animated image is obtained with an animation sampling rate in the order of Hz.

13. Method as claimed in any of the previous claims, characterised in that it comprises the step of associating to said text message, in view of its reception (17), at least a field for identifying a characteristic of said video content selected within the group constituted by:
a virtual character (P) to be used for the presentation of said text message, and
the background (A) of said multimedia content.

14. Method as claimed in any of the previous claims, characterised in that it comprises the step of providing, in said sender terminal (18), a script function for the selection of said video content and of said recipient terminal (12, 13, 14).

15. Method as claimed in any of the previous claims, characterised in that it comprises the step of providing, in said sender terminal (18), a function for the automatic correction of any error which may be contained in said text message.

16. Method as claimed in any of the previous claims, characterised in that it comprises the step of associating to said text message meta-information for selectively modifying the characteristics of said video content.

17. Method as claimed in any of the previous claims, characterised in that it comprises the step of associating to said text message additional information in the form of emoticons for selectively modifying the characteristics of said video content.

18. Method as claimed in any of the previous claims, characterised in that said video content is selected within the group constituted by:
an animated GIF image ordered in frames, with respective portions of said text message associated thereto,
an animated GIF image accompanied by compressed audio, and
a video clip completed with audio.

19. System for transmitting messages on a telecommunications network, characterised in that it comprises:
a reception module (17) for receiving a text message from a sender terminal (18),
a processing set (16) having at least a data base (302, 314, 330) of video information and at least an integration module (326, 328) for integrating said text message with a video content, to generate a multimedia message, and
a transmission module (10) for transmitting to at least a recipient terminal (12, 13, 14) said multimedia message in the form of an MMS message.

20. System as claimed in claim 19, characterised in that said reception module (17) is configured to receive from said sender terminal (18) a text message in the form of an SMS message.

21. System as claimed in claim 19 or claim 20, characterised in that it comprises:
a detection module (300;10) for detecting the type of recipient terminal (12, 13, 14) intended as the recipient of said multimedia message by identifying the characteristics (TD) of said recipient terminal, and
a module (16,326;10) for adapting said MMS message to the characteristics of said recipient terminal (12, 13, 14).

22. System as claimed in claim 21, characterised in that said integration module (326, 328) is configured for integrating said text message with a generated video content (326) in such a way that said multimedia message is suited to the characteristics of said recipient terminal (12, 13, 14).

23. System as claimed in claim 21, characterised in that said integration module (326, 328) is configured to integrate said text message with a determined video content independently from the characteristics of the recipient terminal (12, 13, 14) and in that the system has, associated thereto, a module for the transmission of MMS messages (10) configured to subject said multimedia message to an step (10) of adapting it to the characteristics of said recipient terminal (12, 13, 14).

24. System as claimed in any of the previous claims 19 to 23, characterised in that it comprises at least a video generator module (302, 308, 310) to generate video content selected within the group constituted by:
an animated image,
a background image, and
an image with variable viewpoint.

25. System as claimed in any of the previous claims 19 to 24, characterised in that it comprises a voice synthesiser (306) to synthesise from said text message a voice signal (V) able to be associated (326) to said video content within said multimedia message.

26. System as claimed in claim 25, characterised in that to said video generator module (302, 308, 310) and to said voice synthesiser (306) is associated at least a motion generation module (308, 310) to generate said animated image as an image of a character that pronounces the synthesised voice signal corresponding to said text signal.

27. System as claimed in claim 26, characterised in that said motion generation module (308, 310) is a text animation system, such as the JoeXpress® system.

28. System as claimed in any of the previous claims 19 to 27, characterised in that it comprises a database (330) of background music co-operating with said at least an integration module (326, 328) to integrate said MMS message with background music.

29. System as claimed in any of the previous claims 19 to 28, characterised in that said integration module (326, 328) is configured to include in said video content an animated GIF image.

30. System as claimed in any of the previous claims 24, 26, 27 or 29, characterised in that said integration module (326, 328) is configured to include in said video content an animated image with an animation sampling rate in the order of Hz.

31. System as claimed in any of the previous claims 19 a 30, characterised in that said reception module (17) includes an information extraction block (300) for extracting from said text message received from said sender terminal (18) at least a field identifying a characteristics of said video content, selected within the group constituted by:
a virtual character (P) to be used for the presentation of said text message, and
a background (A) of said multimedia content.

32. System as claimed in any of the previous claims 19 to 31, characterised in that said processing set (16) having said at least a database (302, 314, 330) of video information and said at least an integration module (326, 328) to integrate said text message with a video content is configured to generate a multimedia message selected within the group constituted by:
an animated GIF image ordered in frames, with associated respective portions of said text message,
an animated GIF image complete with a compressed audio, and
a video clip complete with audio.

33. Sender terminal for a system as claimed in any of the previous claims 19 to 32, characterised in that said sender terminal (18) is provided with a script function for selecting said video content and said recipient terminal (12, 13, 14).

34. Sender terminal for a system as claimed in any of the previous claims 19 a 32, characterised in that said sender terminal (18) is provided with a function of automatic correction of any error which may be contained in said text message.

35. Sender terminal for a system as claimed in any of the previous claims 19 a 32, characterised in that said sender terminal (18) is provided with a function for associating to said text message meta-information for selectively modifying the characteristics of said video content.

36. Sender terminal for a system as claimed in any of the previous claims 19 a 32, characterised in that said sender terminal (18) is provided with a function for associating to said text message additional information in the form of emoticons for selectively modifying the characteristics of said video content.
